(19) United States
(12) Patent Application Publication
(10) Pub. No.: US 2002/0179591 A1
(43) Pub. Date: Dec. 5, 2002

(54) Heated vaccine pack

(76) Inventors: Kimberly Quinn, Kenansville, NC (US); Thomas Hogan, Marietta, GA (US)

Correspondence Address: WILLIAM B. DYER III, 263 SKYLAND DR, ROSWELL, GA, 30075, US

(21) Appl. No.: 09/872,089

(22) Filed: Jun. 1, 2001

(51) Int. Cl. F27D 11/00; H05B 3/06

(52) U.S. Cl. 219/438; 604/232; 219/521

(57) ABSTRACT

A heated vaccine pack for heating and keeping heated medicine for vaccinating livestock. The vaccine pack comprises a generally cylindrical container with an inner wall, an exterior wall, and an opening in the bottom of the container. A self contained electrical heating element is located between the wall exterior and the wall interior. The amount of heat to be applied or the operating temperature of the container may be controlled by using an optional temperature regulator. A fastener is affixed to the exterior of the container near the container's top end. The container top has a closure to seal the vaccine pack once the medicine has been placed inside.

### TECHNICAL FIELD

The present invention relates to devices for heating animal medicine in cold or wet conditions.

### BACKGROUND INFORMATION

In the food animal industry, it is standard practice for livestock, such as cattle, hogs, etc., to receive inoculations to prevent disease and/or as treatment for an illness. These inoculations often are done through the use of hypodermic needles.

Many cattle ranches throughout the world are located in rural areas with severe climate variations. For example, in the Midwestern United States, daily average ambient temperatures frequently remain below freezing during most of the winter. Precipitation, such as snow or freezing rain, often accompany these freezing conditions.

Additionally, cattle ranches are spread out across vast stretches of land. When cattle ranchers are ready to inoculate the cattle, the cattle may be herded together in holding pens or in pastures. These inoculation areas may or may not be near sources of commercial electricity. Furthermore, the time required to complete the inoculation process for can last several hours. Even if the medicine is heated before being transported to the inoculation area, it can become cold in a relatively short period of time.

When the medicine to be used for a cattle inoculation becomes too cold, several problems arise. First, the medicine becomes thick, making injections more difficult. Also, the chemical composition of the medicine itself may become damaged, thus reducing the effectiveness of the medicine and increasing the likelihood of disease and meat contamination.

A limited solution to these problems is accomplished by the device taught in U.S. Pat. No. 5,911,709, dated Jun. 15, 1999, titled Vaccine Pack (“VAC PAC”), invented by Hogan and specifically incorporated by reference herein. This device implements a cylindrical container that insulates the medicine bottle from severe elements and slows the negative effects of the ambient conditions on the medicine.

However, the above-described invention can keep the medicine warm for only a finite amount of time. If the medicine remains outdoors exposed to severe ambient conditions for an extended period of time, it can cool to near ambient temperature even though it is contained within the VAC PAC device.

Once the medicine has become too cold, it must be removed from the VAC PAC and be reheated.

Accordingly, there is a need for a device that allows application of heat to a container of medicine to keep the medicine at a desirable temperature for an extended period of time. There is a further need for such a device that can use different power supply types.

There is still further need for a device implementing the above-stated functionality that uses a self contained integral electrical heating element to facilitate the medicine being heated to and remaining at the desired temperature.

Yet another need exists for a device that uses a temperature regulator, permitting greater control over temperature selection and heat application.

A final need exists for a device shielded by a water resistant material, thus keeping the medicine warm for a longer period of time.

### BRIEF SUMMARY OF THE INVENTION

The above described and other shortcomings relating to the use of animal medicine delivery are satisfied by the present invention. More specifically, the present invention relates to a heated vaccine pack for heating and keeping heated medicine for vaccinating livestock. The vaccine pack comprises a generally cylindrical container with an inner wall and exterior wall. A container bottom opening allows the medicine to be extracted from the container for injection into the animal.

In an embodiment of the present invention, a self-contained integral electrical heating element is located between the wall exterior and the wall interior. The electrical power used by the heating element can be alternating current or direct current. The electrical power source could be standard utility service, from a battery pack, or through a vehicle's battery. The amount of heat to be applied or the operating temperature of the container may be controlled by using a temperature-regulating device.

A fastener is affixed to the exterior of the container near the container's top end. This allows the user to hang the container to hang from a rack or a similar device.

The container top has a closure to substantially seal the vaccine pack once the medicine has been placed inside. The closure mechanism could consist of drawstrings, VELCRO™, snaps, zippers, buttons, flaps, and lids.

In a preferred embodiment, the exterior of the device incorporates water resistant and insulative characteristics.

### BRIEF DESCRIPTION OF THE DRAWINGS

FIG. 1 depicts an exemplary embodiment of the present invention.

FIG. 2 is a top view of the present invention exhibiting the container bottom opening.

### DETAILED DESCRIPTION

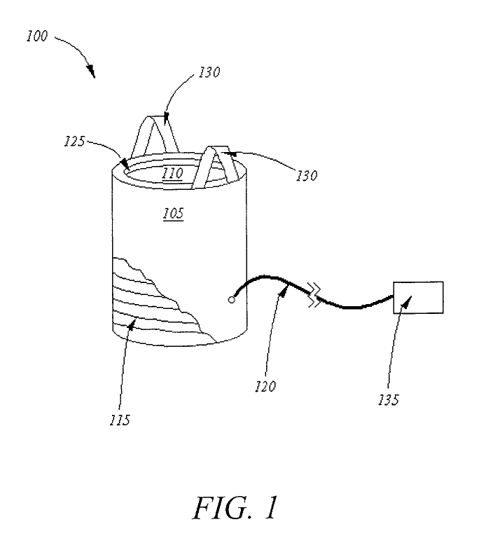

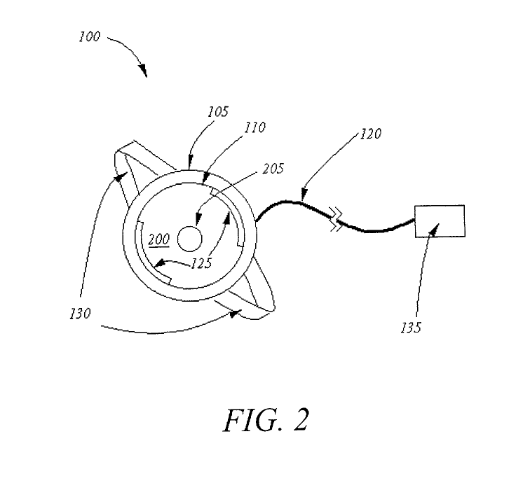

FIG. 1 depicts an exemplary embodiment of a vaccine pack 100. More specifically, the vaccine pack 100 comprises a cylindrical container wall having a cylindrical container wall exterior 105, a cylindrical container wall interior 110, the wall interior 110 further defining a cylindrical space sized to accommodate a medicine bottle (not shown). The wall exterior 105 and the wall interior 110 may be constructed of any durable, flexible, and cleanable material such as cloth or plastic. Materials having water resistant or water proof characteristics, such as nylon or GORE-TEX™, are preferred because they enhance the heating function of the vaccine pack 100 by removing moisture from the heating process. Similarly, materials having high insulative characteristics, such as Styrofoam and gels, are preferred to enhance the heating function of the vaccine pack 100 because they reduce heat dissipation from the vaccine pack 100 and better insulate the medicine from cold ambient conditions. The preferred embodiment includes a container bottom having a container bottom opening later described with reference to FIG. 2. A medicine container which contains the medicine to be injected into the animal is placed inside the cylindrical space defined by the wall interior 110 of the vaccine pack 100 with the medicine container opening extending out of the vaccine pack 100 through the container bottom opening.

An integral electrical heating element 115 is preferably contained between the wall exterior 105 and the wall interior 110 to permit the application of heat to medicine contained in the vaccine pack 100. In a preferred embodiment, the integral electrical heating element is the well-known electric resistance type. The integral electrical heating element 115 is powered through a power cord 120 electrically connected to a power source 135. The power source 135 could be alternating or direct current from a variety of stationary or mobile sources of electricity, such as electric utility service, battery packs, or vehicle power sources.

In another embodiment, a temperature regulator such as a thermostat may be used to provide more precise heating control of the electrical heating element and thereby the medicine contained in the vaccine pack 100.

In a preferred embodiment, the vaccine pack 100 may have at least one fastener 130 attached to the container top. The fasteners 130 provide a means for securing the vaccine pack 100 to a rack or other similar holding device, thus not requiring the user to hold the vaccine pack 100 in one or both hands while engaged in other tasks. The fasteners 130 may be manufactured of a variety of materials and take several forms. For example, the fasteners 130 may be in the form of loops (as depicted in FIG. 1), cords, buttons, or other devices used for attaching objects to each other. The fasteners 130 can be used to hang the vaccine pack 100 on a rack or similar holding device.

The preferred embodiment of the vaccine pack 100 includes a closure 125 for the container top. A function of the closure 125 is to seal the container once medicine is placed in the vaccine pack 100. The closure 125 prevents applied heat from escaping the vaccine pack 100 and allows for more efficient and economical heating of the medicine. The closure 125 may take several forms, such as a lid, a flap, VELCRO™, zippers, buttons, snaps, or drawstrings. After the medicine container is placed inside the vaccine pack 100, the closure 125 can be secured to seal the vaccine pack 100.

Turning now to FIG. 2, a top view of an embodiment of the present invention is depicted. More specifically, the vaccine pack 100 comprises a cylindrical container wall having a cylindrical container wall exterior 105, a cylindrical container wall interior 110, the wall interior 110 further defining a cylindrical space sized to accommodate a medicine bottle (not shown). The preferred embodiment includes a container bottom 200 having a container bottom opening 205. A medicine container which contains the medicine to be injected into the animal is placed inside the cylindrical space defined by the wall interior 110 of the vaccine pack 100 with the medicine container opening extending out of the vaccine pack 100 through the container bottom opening 205.

In a preferred embodiment, the vaccine pack 100 may have at least one fastener 130 attached to the container top. The fasteners 130 provide a means for securing the vaccine pack 100 to a rack or other similar holding device, thus not requiring the user to hold the vaccine pack 100 in one or both hands while engaged in other tasks. The fasteners 130 may be manufactured of a variety of materials and take several forms. For example, the fasteners 130 may be in the form of loops (as depicted in FIG. 2), cords, buttons, or other devices used for attaching objects to each other. The fasteners 130 can be used to hang the vaccine pack 100 on a rack or similar holding device.

The preferred embodiment of the vaccine pack 100 includes a closure 125 for the container top. A function of the closure 125 is to seal the container once medicine is placed in the vaccine pack 100. The closure 125 prevents applied heat from escaping the vaccine pack 100 and allows for more efficient and economical heating of the medicine. The closure 125 may take several forms, such as a lid, a flap, VELCRO™, zippers, buttons, snaps, or drawstrings. After the medicine container is placed inside the vaccine pack 100, the closure 125 can be secured to seal the vaccine pack 100.

As will be apparent to one skilled in the art of medicine applications, the present invention will find use in industries far wider than the food animal industry. For example, the present invention may also find uses such as heating intravenous liquids for injection into humans.

It will be understood and appreciated that the spirit and scope of the present invention is not limited to the particular embodiments referenced and discussed herein, but to the claims appended hereto.

We claim:

1. A heated vaccine pack, comprising:
a cylindrical container having a first end, a second end, a cylindrical container wall extending between the first end and the second end, the cylindrical container wall having a wall exterior and a wall interior defining a wall thickness therebetween, the wall interior further defining a cylindrical space, and a container bottom affixed to the second end of the cylindrical container and defining a container bottom opening therein;
a fastener affixed to the wall exterior of the cylindrical container proximal to the first end of the container;
a self contained integral electrical heating element located between the wall exterior and the wall interior; and
a closure for closing the container top.

2. The heated vaccine pack as described in claim 1, wherein the integral electrical heating element uses alternating current.

3. The heated vaccine pack as described in claim 1, wherein the integral electrical heating element uses direct current.

4. The heated vaccine pack as described in claim 1, wherein the integral electrical heating element has a temperature regulator.

5. The heated vaccine pack as described in claim 1, wherein the wall exterior is manufactured from a water resistant material.

6. The heated vaccine pack as described in claim 1, wherein the fastener is two loops.

7. The heated vaccine pack as described in claim 1, wherein the closure for closing the container top is VELCRO™.

8. A heated vaccine pack, comprising:
a container which comprises a container exterior, a container interior, a container top, a container bottom having a container bottom opening therein, and a container exterior opening;
two loops fastened to said container exterior at the top of said container;
a self contained integral heating element located between said container exterior and said container interior; and
a closure for closing the container top.

9. The heated vaccine pack as described in claim 8, wherein the heating element uses alternating current.

10. The heated vaccine pack as described in claim 8, wherein the heating element uses direct current.

11. The heated vaccine pack as described in claim 8, wherein the heating element has a temperature regulator.

12. The heated vaccine pack as described in claim 8, wherein the exterior wall is manufactured from a water resistant material.

13. The heated vaccine pack as described in claim 8, wherein the closure for closing the container top is VELCRO™.
